(19) United States
(12) Patent Application Publication
(10) Pub. No.: US 2017/0126091 A1
(43) Pub. Date: May 4, 2017

(54) ELECTRONICALLY COMMUTATED ELECTRIC MOTOR AND CORRESPONDING AIR BLAST DEVICE

(71) Applicant: Valeo Systemes Thermiques, Le Mesnil Saint Denis (FR)

(72) Inventors: Geoffroy Capoulun, Versailles (FR); Eric Ballay, Ecquevily (FR)

(73) Assignee: Valeo Systemes Thermiques, Le Mesnil Saint Denis (FR)

(21) Appl. No.: 15/336,862

(22) Filed: Oct. 28, 2016

(30) Foreign Application Priority Data
Oct. 29, 2015 (FR) 1560361

(51) Int. Cl. H02K 5/173; F04D 25/06; B60H 1/00

(52) U.S. Cl. CPC H02K 5/173; B60H 1/00428; F04D 25/062

(57) ABSTRACT

An electronically commutated electric motor according to the invention is notably used in an air blast device and in a motor vehicle heating, ventilating and/or air-conditioning installation.

The motor comprises a rotor (16) and a stator (14).

The stator is mounted on a metal support means (10) that is arranged so as to protrude from a bearing plate (12) and is electrically connected to an electrical earth.

And a screen (34) is disposed between the rotor and the stator, said screen also being electrically connected to the electrical earth.

The present invention relates to the field of electric motors, and notably to that of electronically commutated motors. More specifically, it relates to air blast devices in motor vehicles comprising such electric motors.

An air blast device equipped with an electric motor according to the invention is used for example in a motor vehicle ventilating, heating and/or air-conditioning system.

Electronically commutated electric motors, or brushless DC motors, comprise a rotor and stator assembly, each of these components bearing electromagnetic elements, the interaction of which generates the movement of the rotor relative to the state and sets a drive shaft carded by the rotor into rotation. The current switching in the coils of the stator generates electric fields which can disturb the operation of other electronic appliances disposed in the vicinity.

Furthermore, the rotor is mounted so as to rotate about the stator by way of the rotation of the drive shaft to which it is secured. The rotor and the stator are mounted independently of one another in said motor, and it is necessary to ensure that the relative position of these two components is correct for optimal operation of the motor. The aim is to ensure that the rotor rotates about the stator at a constant distance from the latter, meaning that the drive shaft is substantially coaxial with the axis of revolution of the part forming the stator. It is thus necessary to pay particular attention to the bearings which support the rotation of the drive shaft.

Embodiments are known in which at least one rolling bearing is placed in a housing formed in the casing of the stator, said casing being made of plastics material. Such an arrangement cannot ensure a stable position of the rolling bearings, on account of the thermal expansion of the plastics material. The fact that one and/or the other of the housings of the rolling bearings can deform and move the corresponding rolling bearing results in shifting of the orientation of the drive shaft, which can be disadvantageous for the optimal efficiency of the electric motor.

The present invention falls in this double context, namely the problem of confining electromagnetic waves and the problem of correctly positioning the stator and the rotor, it being understood that it aims to propose an electric motor and an associated air blast device, the operation of which is optimal and without electromagnetic disturbance of the appliances disposed in the vicinity.

An air blast device is understood to be a device for drawing in and/or blowing air.

The electronically commutated electric motor comprises a stator mounted on a support means and a rotor secured to an output shaft mounted so as to rotate with respect to the stator and to the, fixed, support means by way of rolling bearings. According to the invention, a screen is disposed transversely facing one of the faces of the stator and this screen comprises a housing that is able to hold one of said rolling bearings.

According to various features of the invention, taken on their own or in combination, the following may be provided:

the screen is electrically connected to the support means, which is electrically connected to an electrical earth; this arrangement allows the formation of a conductive enclosure connected to the electrical earth, and thus kept at a fixed potential, so as to form shielding that is able to at least partially confine, within the air blast device, the electrical field created by the current switching in the coils of the stator which generate electrical fields;

the screen extends radially over the entire diameter of the stator;

the screen is pierced at its centre by a bore so as to be passed through by an output shaft of the motor;

the housing is formed around said bore, said housing comprising a bottom wall and a peripheral edge;

the screen is designed so as to have several tiers, at least one tier forming a covering part and one tier forming the housing;

the tiers are connected by a dropped edge substantially parallel to the axis of revolution of the screen;

the screen also comprises an intermediate tier forming a part for fastening to the stator;

the fastening part comprises a plate provided with at least one fastening hole; advantageously, the plate is provided with three fastening holes that are regularly distributed angularly;

the screen is made of an electrically conductive metal material;

the screen is fastened to the stator by at least one fastening means, notably a fastening screw, or, as an alternative example, a rivet, that passes through the stator so as to be engaged with the support means;

the motor comprises two screens, each comprising a housing that is able to hold one of said rolling bearings, a first screen being disposed transversely facing the upper face of the stator while a second screen is disposed transversely facing the lower face of the stator;

the two screens are fastened to the stator by the same type of fastening means, for example fastening screws, which pass through the stator so as to be engaged with the support means;

the support means is connected to a bearing plate which forms a heat sink bearing an electronic control board, notably for powering the stator coils, the bearing plate being electrically connected to the electrical earth of the electronic control board.

The present invention also relates to an air blast device and a motor vehicle heating, ventilation and/or air-conditioning installation comprising at least one electronically commutated electric motor as has just been described.

Further features and advantages of the invention will become apparent from reading the detailed description of an embodiment which follows and for an understanding of which reference is made to the appended drawings, in which:

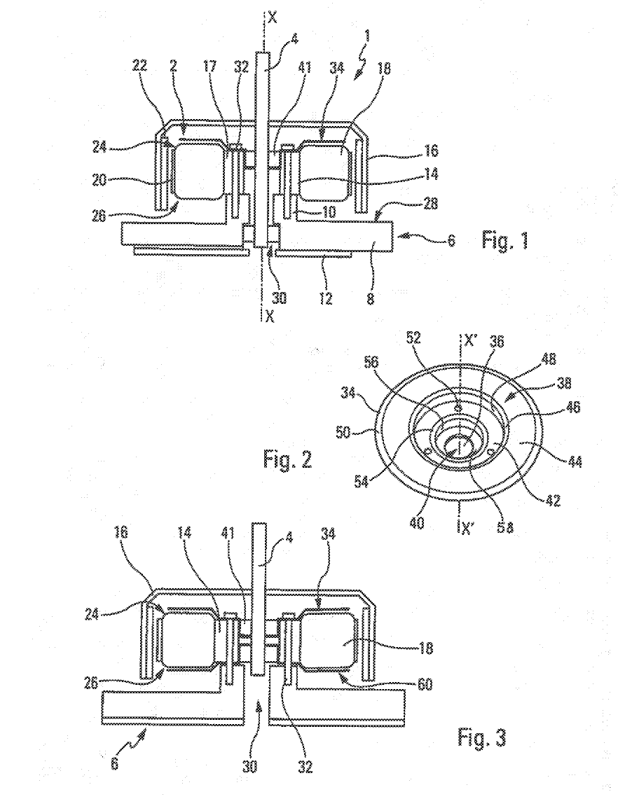

FIG. 1 is a cross-sectional depiction of an air blast device according to a first embodiment of the invention;

FIG. 2 is a perspective view of a shielding screen with which the device in FIG. 1 is equipped;

and FIG. 3 is a depiction similar to the one in FIG. 1 of an air blast device according to a second embodiment of the invention.

An air blast device 1, for drawing in and blowing air, comprises at least one electronically commutated electric motor 2 that is able to drive a fan wheel in rotation by way of an output shaft 4 of the electric motor. A support means 6 of the electric motor 2 comprises a bearing plate 8 from which a stub 10 protrudes and which bears an electronic control board 12 of said electric motor 2, said bearing plate 8 also forming a means for cooling the components of said device. The support device is described here as being a one-piece part in which the stub 10 is formed integrally with the bearing plate 8, but it will be understood that it could be two independent parts joined to one another.

The electric motor 2 mainly comprises a stator 14 and a rotor 16 bearing the output shaft 4. The stator 14 is secured to the support means 6 and the rotor 16 is arranged around the stator 14 so as to be driven in rotation under the effect of the magnetic field generated by the winding and the magnets associated with the rotor and the stator.

The stator 14 has an axisymmetrical form around a main axis X-X′, substantially parallel to the rotation axis of the rotor. The stator comprises notably a central part 17 from which a plurality of arms extend in a star shape, each arm being able to hold a wire winding 18 that forms an electromagnetic coil.

The stator 14 has a peripheral face 20 that notably bears metal plates that are able to cooperate with a permanent magnet 22 of the rotor 16, and also two transverse faces. An orientation in which the transverse face of the stator disposed facing the rotor is the upper transverse face 24 and the transverse face of the stator disposed facing the support means is the lower transverse face 26 is arbitrarily defined. The central part 17 of the stator comprises a through-bore that extends from the upper transverse face 24 to the lower transverse face 26 of the stator 14.

In the air blast device 1 comprising the electric motor 2 according to the invention, the stator 14 and the rotor 16 are arranged such that the rotor is disposed around the stator, the latter being disposed facing the bearing plate 8.

The stub 10 of the support means 6 protrudes from a first face 28 of the bearing plate 8, while the electronic board 12 is fastened to a second, opposite face of this bearing plate. It will be understood that, as a result, when the components of the device are mounted, the electronic board is turned away from the electric motor. The bearing plate is fastened mechanically with respect to the structure of the vehicle and it is connected electrically to the earth of the electronic member.

The support means 6 has an axisymmetrical form and the bearing plate 8 extends in a plane substantially perpendicular to this axis of revolution of the support means 6. The stub 10 and the bearing plate 8 of the support means 6 are passed through by an internal passage 30 that leads out substantially at the centre of the bearing pate 8. It will be understood that the support means 6 makes it possible to fasten the stator 14 and to hold the motor output shaft 4 secured to the rotor 16, such that this support means 6 helps to correctly position the rotor 16 with respect to the stator 14. As has been able to be specified above, the stub can be fastened to the bearing plate by different means and notably welding means, or it can be obtained in one piece with the bearing plate.

Preferably, the bearing plate 8 is made of metal. Thus, the bearing plate acting as a heat sink can effectively cool the electronic member by heat conduction. In addition, the fact that the bearing plate is made of electrically conductive materials and is connected to the electrical earth of the electronic member makes it possible to at least partially block electromagnetic radiation emitted by the electronic member, this radiation being able to disturb the operation of the electric motor. Preferably, the bearing plate is made of aluminium, such that these parts are associated with characteristics of lightness and good thermal conduction. The stator 14 is fastened to the support means 6; notably, the stator 14 can be screwed to the free end wall of the stub 10, about the internal passage 30, by way of fastening screws 32, the tightening force of which makes it possible to press the lower face of the stator against the free end wall of the stub.

It is particularly notable according to the invention that the electric motor 2 formed by the rotor 16 and the stator 14 also comprises a screen 34 forming an electromagnetic shielding means for avoiding the propagation of electromagnetic radiation outside the motor and the air blast device.

The screen 34 is disposed between the rotor 16 and the stator 14, transversely with respect to the output shaft 4. This screen is made of an electrically conductive material, notably of aluminium, and is electrically connected to the electrical earth. In order to form a confinement means, the screen 34 extends transversely over the entire diameter of the stator and is fastened to the stator.

In FIG. 2, the screen 34 has a disc shape that is pierced at its centre by a bore 36 so as to be passed through by the output shaft 4 of the motor. The screen 34 has an axisymmetrical form around an axis of revolution X′-X′ substantially parallel to the main axis of revolution X-X of the stator 14 when the air blast device is assembled.

The disc has at least two tiers, that is to say two functional parts which extend at different heights from one another around the axis of revolution X′-X′. A first tier consists of a covering part 38 for the stator when the screen 34 is assembled on the stator 14, and a second tier consists of a housing 40 that is able to hold a rolling bearing 41 arranged around the bore 36.

In the embodiment illustrated, an intermediate tier is formed between the first and the second tier, said intermediate tier consisting of a fastening plate 42 for fastening the screen 34 to the stator 14. The covering part 38 is formed by a flat annular wall 44, the inner edge 46 of which is extended in a substantially perpendicular manner by a first dropped edge 48 which connects the first tier to the intermediate tier in a manner parallel to the axis of revolution X′-X′ of the screen. The flat annular wall 44 extends radially between the inner edge 46 and an outer edge 50, over a distance that makes it possible to cover the coils associated with the stator 14. As illustrated, the outer edge 50 is in the plane defined by the flat annular wall 44, but it will be understood that it could be extended so as to form a curved part at the end of the screen.

The fastening plate 42 forming the intermediate tier extends in continuation of the first dropped edge 48 and it extends substantially parallel to the flat annular wall 44 of the covering part 38. The fastening plate 42 radially extends the covering part towards the centre of the screen 34. At least one fastening hole 52 is made in the fastening plate 42, and advantageously three fastening holes that are distributed regularly at 120° are provided.

The fastening plate 42 also has an annular shape, the inner edge 54 of which is extended in a substantially perpendicular manner by a second dropped edge 56 which connects the intermediate tier to the second tier in a manner parallel to the axis of revolution X′-X′ of the screen. The fastening plate extends radially between the inner edge 54 and the first dropped edge 48 over a distance that makes it possible for the screen to be pressed against the stator in order to be fastened via the fastening holes 52.

The housing 40 forming the second tier is obtained by the second dropped edge 56 and a bottom wall 58 that is pierced at its centre so as to allow the output shaft of the motor to pass through when the screen 34 is attached to the stator 14. The bottom wall 58 and the second dropped edge 56 delimit an upwardly open cavity so as to form the housing 40, the second dropped edge 56 forming the peripheral wall of the housing, against which the outer race of the rolling bearing 41 comes to rest. It will thus be understood that the housing 40 is dimensioned depending on the dimension of the rolling bearing to be housed in the cavity. Provision could be made to make a groove (not shown here) in this housing, in the peripheral wall formed by the second dropped edge 56, said groove being able to receive an elastic ring for keeping the roving bearing in position in the housing.

The screen 34 as has just been described, that is to say with a plurality of tiers forming at least one transverse covering part for the stator, a part for fastening to the stator and a part for housing a rolling bearing, is made by stamping a metal plate, notably an aluminium plate.

The mounting of such a screen and of an associated rolling bearing on a stator of an electric motor will now be described.

The screen 34 is positioned facing the upper face 24 of the stator such that the fastening holes 52 of the screen are disposed in line with the tapped fastening holes formed in the stator 14. Fastening screws 32 are inserted into these various superposed holes and they engage with the tapped holes such that the screw head presses the stator 14, and the screen 34 against the support means 6. The outer race of the rolling bearing 41 is then disposed in the housing, pressed against the bottom wall 58. This rolling bearing 41 can be a ball bearing, a roller bearing, a needle bearing, or the like. A second rolling bearing is housed in the support means 6 in order to guide the output shaft in rotation.

Furthermore, the screwing of the screen 34 and of the stator 14 to the support means participates in the electrical earthing of the screen, the screw shank being in contact with the support means, itself connected to the electrical earth, while the screw head is pressed against the screen. Thus, through the presence of the metal screen connected to a constant electric potential of essentially zero, a shielding means that prevents the diffusion of electromagnetic waves is formed, and it is interesting to note that the covering part 38 is bordered towards the inside of the screen 34 by the first dropped edge 48 which forms a wall limiting the propagation of electromagnetic waves outside the motor through the centre of the screen.

A second embodiment of an electronically commutated electric motor will now be described, this second embodiment differing from the first embodiment described above in that two transverse screens are disposed facing the stator so as to form an electromagnetic shielding means, a first screen 34 facing the upper transverse face 24 of the stator as before, and a second screen 60 this time facing the transverse lower face 26 of the stator, that is to say between the stator 14 and the support means 6.

This second screen 60 is similar to the first screen 34 in its tiered arrangement. It will be understood that the second screen 60, on facing the lower transverse face 26, takes up an opposite disposition to that of the first screen, so that, like the latter, the covering part is axially spaced apart from the wire winding 18. The fastening holes present in the fastening plate of the second screen 60 are disposed in line with the fastening holes 52 in the first screen 34 and the fastening holes in the stator in order to be passed through by the same fastening screws 32 which connect the first screen 34 and the stator. The screwing of the fastening screws 32 helps to clamp the second screen 60 between the lower face 26 of the stator and the support means 6, allowing it to be fastened, for the one part, and to be earthed, for the other part.

The above description aims to explain how the invention makes it possible to achieve the objectives that have been set therefor and notably to propose an electronically commutated electric motor and an associated air blast device in which the electromagnetic radiation is confined, by production of confinement means that are easy to manufacture, easy to mount and particularly effective, also allowing the integration of a relative positioning function for the stator and the rotor, by integration of a supporting function for at least one rolling bearing for guiding the drive shaft secured to the rotor in rotation. However, the invention is not limited just to the motors and air blast devices in accordance with the embodiments explicitly described with regard to the figures, it being understood that variant embodiments could be implemented without departing from the context of the invention, as long as transverse confinement of the electromagnetic radiation is rendered possible by the earthing of a metal screen disposed between the rotor and the stator of an electric motor, notably an electronically commutated electric motor, and as long as this screen incorporates means for holding a rolling bearing for guiding a drive shaft.

1. An electronically commutated electric motor, said motor comprising a stator mounted on a support means and a rotor secured to an output shaft mounted so as to rotate with respect to the stator and to the support means by way of rolling bearings,
wherein at least one screen is disposed transversely facing one of the faces of the stator, and wherein said screen comprises a housing that is able to hold one of said rolling bearings.

2. The motor according to claim 1, wherein the screen is electrically connected to the support means, which is electrically connected to an electrical earth.

3. The motor according to claim 1, characterized in that said screen (34, 60) extends radially over the entire diameter of the stator (14).

4. The motor according to claim 1, wherein said screen is pierced at its centre by a bore so as to be passed through by the output shaft of the motor.

5. The motor according to claim 4, wherein the housing is formed around said bore, said housing comprising a bottom wall and a peripheral edge.

6. The motor according to claim 5, wherein the screen is designed so as to have several tiers, at least one tier forming a covering part and one tier forming the housing.

7. The motor according to claim 6, wherein the tiers are connected by a dropped edge substantially parallel to the axis of revolution of the screen.

8. The motor according to claim 7, wherein the screen also comprises an intermediate tier forming a part for fastening to the stator.

9. The motor according to claim 1, wherein the screen is fastened to the stator by at least one fastening means that passes through the stator so as to be engaged with the support means.

10. The motor according to claim 1, further comprising two screens comprising a housing that is able to hold one of said rolling bearings, a first screen being disposed transversely facing the upper face of the stator while a second screen is disposed transversely facing the lower face of the stator.

11. The motor according to claim 10, wherein the two screens are fastened to the stator by the same type of fastening means, which pass through the stator so as to be engaged with the support means.

12. The motor according to claim 1, wherein the support means is connected to a bearing plate which forms a heat sink bearing an electronic control board, for powering the stator coils, the bearing plate being electrically connected to the electrical earth of the electronic control board.

13. An air blast device comprising at least one electronically commutated electric motor according to claim 1.

14. A motor vehicle heating, ventilating and/or air-conditioning installation comprising at least one air blast device according to claim 13.
